(19) United States
(12) Patent Application Publication
(10) Pub. No.: US 2007/0177475 A1
(43) Pub. Date: Aug. 2, 2007

(54) Method and apparatus to reproduce data with an improved data error correction capability

(75) Inventors: Hyun-jung Kim, Suwon-si (KR); Sung-hee Hwang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/636,636

(22) Filed: Dec. 11, 2006

(30) Foreign Application Priority Data
Jan. 31, 2006 (KR) 2006-9388

(51) Int. Cl. G11B 27/36; G11B 20/10

(52) U.S. Cl. 369/53.34; 369/59.22

(57) ABSTRACT

A method and apparatus to reproduce and/or record data from and/or to an optical recording medium. The method includes detecting a wobble signal from the optical recording medium, predicting a wobble channel state from the detected wobble signal, detecting an information signal from the optical recording medium, predicting an information channel state from the detected information signal. If a damaged section is discovered from the optical recording medium, the information signal is decoded based on the information on the wobble channel state or the information on the information channel state. Accordingly, data can be reproduced more effectively by predicting a channel state of an information (RF) signal and a channel state of a wobble signal.

### CROSS-REFERENCE TO RELATED APPLICATION

This application claims all benefits accruing under 35 U.S.C. §119 from Korean Patent Application No. 2006-9388, filed Jan. 31, 2006 in the Korean Intellectual Property Office, the disclosure of which is incorporated herein by reference.

### BACKGROUND OF THE INVENTION

1. Field of the Invention

Aspects of the present invention relate to a method and apparatus to reproduce data from an optical recording medium.

2. Related Art

FIG. 1 is a block diagram of a conventional apparatus 100 to record and/or reproduce data onto and/or from an optical recording medium. As shown in FIG. 1, in order to operate properly, the apparatus 100 requires a radio frequency (RF) signal detecting unit to detect an RF signal in a light beam reflected from the optical recording medium. Further, if the data is to be recorded, the apparatus 100 may additionally require a wobble signal detecting unit to detect a wobble signal.

The RF signal detecting unit conventionally employs a method in which a slicer is used. Recently, however, since recording densities are increasing and since interference and noise components are included in the radio frequency (RF) signal, the conventional RF signal detecting unit now conventionally employs methods such as a partial response maximum likelihood (PRML) method.

The PRML method is a likelihood analysis method for an input signal. In general, to use the PRML signal, since an analog input signal must be converted to a digital signal, an analog-to-digital converter (ADC) is necessary, and an equalizer to match a desired channel characteristic may be additionally needed. A phase-locked loop (PLL) circuit to generate an operational clock signal is also needed.

The wobble signal detecting unit is usually used to detect a rotational speed of a disc and current location information of recordable data. As such, a PLL circuit is needed to generate a write clock from the detected wobble signal. An ADC may also be used to convert the wobble signal to a digital signal to obtain location information included in the wobble signal.

A conventional optical recording medium has a track configuration illustrated in FIG. 2. As shown in FIG. 2, data is stored in the center of each track, and a sine wave wobble signal is stored in a wobble track around each track. Address data may be additionally included in the wobble signal if necessary.

With reference again to FIG. 1, an operation of the wobble signal detecting unit to detect a wobble signal, which is included in the apparatus 100, will now be described as follows. Address information is detected by a conversion of a wobble signal reproduced from the wobble track to a digital signal using an ADC 110 and by a processing of the digital signal using a wobble PLL 120.

An analog signal that is reproduced from the center of a track is converted into a digital signal by an ADC 130, and a clock signal is generated from the digital signal using a PLL 140. The digital signal is corrected using an equalizer (EQ) 150, and information data is detected from the corrected digital signal using a PRML module 160. A channel predictor 170 generates channel state information by predicting a channel state using the corrected digital signal that is output from the EQ 150. The channel state information is then used to decode the information data.

With respect to a situation in which an optical recording medium is used, data that is recorded in a certain section of the optical recording medium is frequently damaged due to dust, fingerprints, or scratches as illustrated in FIG. 3. In general, when data is damaged, the data in a damaged section can be recovered by an error correction operation. However, a more effective data recovery method is required.

### SUMMARY OF THE INVENTION

Several aspects and example embodiments of the present invention provide a data reproducing method and apparatus to improve data error correction capability by a prediction of a channel of an optical recording medium using a wobble signal.

In accordance with an example embodiment of the present invention, there is provided a method of reproducing data from an optical recording medium, the method including: detecting a wobble signal from the optical recording medium; predicting a wobble channel state from the detected wobble signal; detecting an information signal from the optical recording medium; predicting an information channel state from the detected information signal; and if a damaged section is discovered from the optical recording medium, decoding the information signal based on the information on the wobble channel state or the information on the information channel state.

According to an aspect of the present invention, the decoding may include decoding the information signal detected from the optical recording medium using a hard decoding method or a soft decoding method.

According to an aspect of the present invention, the decoding may include: PRML processing the information signal detected from the optical recording medium; demodulating the PRML-processed signal; and Reed-Solomon (RS)-decoding the demodulated signal.

According to an aspect of the present invention, the channel state information may indicate error occurrence location information, and at least one of the performing of PRML, the demodulating, and the RS-decoding may comprise performing erasure correction of an information signal on an error occurrence location.

According to an aspect of the present invention, the decoding may include: a channel detection process, wherein, the information signal detected from the optical recording medium is processed using a soft value; a soft demodulation process, wherein the channel detected signal is soft-demodulated; and a channel decoding process, wherein, the soft-demodulated signal is processed using a soft value.

According to an aspect of the present invention, the channel state information may indicate envelope information of the wobble signal, and at least one of the channel detection process, the soft demodulation process, and the channel decoding process may comprise decreasing the envelope of the information signal to decrease a reliability value of the information signal according to a decrease of the envelope of the wobble signal using the envelope information of the wobble signal.

In accordance with another example embodiment of the present invention, there is provided an apparatus to record and/or reproduce data onto and/or from an optical recording medium, the apparatus comprising: a wobble signal detector to detect a wobble signal from the optical recording medium; a wobble channel state predictor to predict a wobble channel state from the detected wobble signal; an information signal detector to detect an information signal from the optical recording medium; and an information channel state predictor to predict an information channel state from the detected information signal. If a damaged section is discovered from the optical recording medium, the information signal detector decodes the information signal based on the information on the wobble channel state or the information on the information channel state.

In addition to the example embodiments and aspects described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of a conventional apparatus to record and/or reproduce data onto and/or from an optical recording medium;

FIG. 2 is a track configuration of a conventional optical recording medium;

FIG. 3 is a track configuration of a conventional optical recording medium in which data in a certain section is damaged due to dust, fingerprints, or scratches;

FIG. 4 is a block diagram of an apparatus to record and/or reproduce data onto and/or from an optical recording medium according to an example embodiment of the present invention;

FIG. 5 is a block diagram of an apparatus to record and/or reproduce data onto and/or from an optical recording medium according to another embodiment of the present invention;

FIG. 6 illustrates a data loss model due to fingerprints, which is used to simulate data reproduction performance according to an embodiment of the present invention; and

FIG. 7 is a diagram showing a simulation result that is obtained by an application of the data loss model illustrated in FIG. 6 to both a conventional method and to a method according to an embodiment of the present invention.

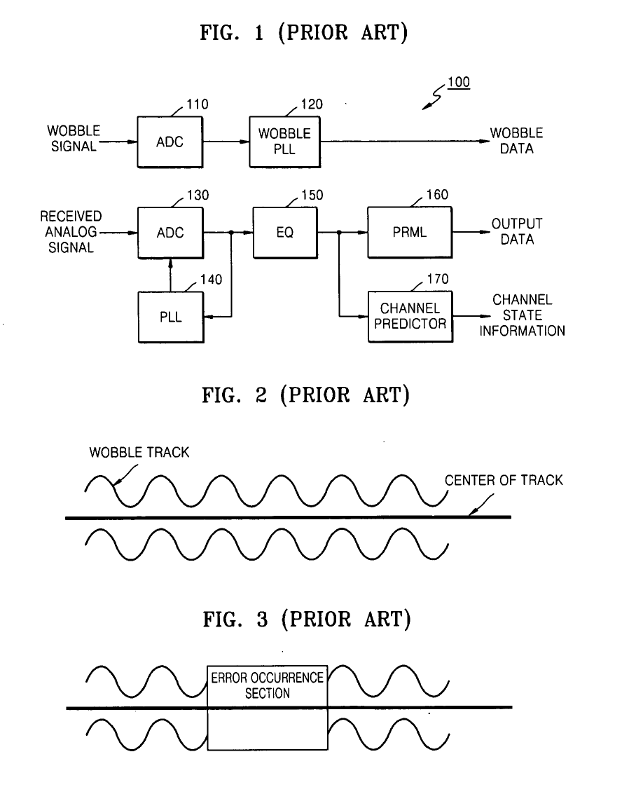

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an aspect of the invention, when a channel, on which data is to be transmitted, cannot be predicted using a radio frequency (RF) signal, the channel may nevertheless be predicted using a wobble signal. For example, when an error in data that is recorded on an optical disc occurs due to fingerprints on the surface of the optical disc, the error may not be detectable using just an RF signal. However, due to the nature of the wobble track, since the amount of wobble signal data tends to be greater than the amount of RF signal data, the error due to fingerprints may be detected more easily using channel information from the wobble signal. Even when a channel is predicted using an RF signal, the accuracy of the channel prediction can be increased by additionally using channel information from a wobble signal.

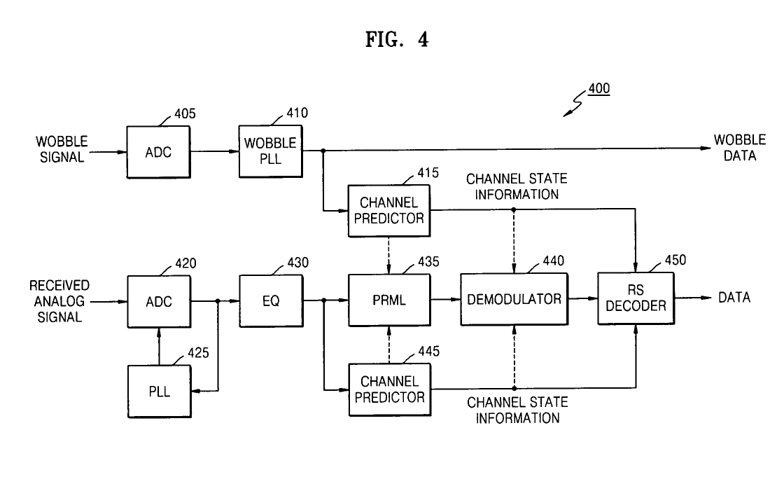

FIG. 4 is a block diagram of an apparatus 400 to record and/or reproduce data onto and/or from an optical recording medium (not shown) according to an example embodiment of the present invention. As shown in FIG. 4, the apparatus 400 includes an ADC 405, a wobble phase-locked loop (PLL) 410, a channel predictor 415, an analog-to-digital converter (ADC) 420, a PLL 425, an equalizer (EQ) 430, a partial response maximum likelihood (PRML) module 435, a demodulator 440, a channel predictor 445, and a Reed-Solomon (RS)-decoder 450. The ADC 405 and the wobble PLL 410 detect a wobble signal from a wobble track of the optical recording medium. Here, it is noted that the ADC 405 may be omitted or replaced with a slicer in accordance with example embodiments of the invention.

The channel predictor 415 predicts a wobble channel state from the detected wobble signal. The channel predictor 415 then extracts envelope information of the wobble signal, determines that an error has occurred if the envelope of the wobble signal is less than that of a wobble signal in a normal state, and provides information about a damaged section in which the error has occurred. In other words, the channel predictor 415 provides error occurrence location information to at least one of the PRML module 435, the demodulator 440, and the RS-decoder 450.

In the meantime, the ADC 420, the PLL 425, the EQ 430, the PRML module 435, the demodulator 440, and the RS-decoder 450 detect an RF signal from the center of a track of the optical recording medium. According to example embodiments of the invention, however, the PRML module 435 is not necessarily required to detect the RF signal and may be omitted or replaced. The channel predictor 445 then predicts an RF channel state from the detected RF signal.

Thus, it is noted that, in the current embodiment, the wobble channel state and the RF channel state are each predicted by the channel predictors 415 and 445, respectively, from information on the RF signal and the wobble signal. This channel state information is then used to decode the RF signal.

As shown in FIG. 4, when the data is reproduced from the optical recording medium using a hard decoding method, the channel state information may be error occurrence location information indicating a location where an error occurs.

In addition, at least one of the PRML module 435, the demodulator 440, and the RS-decoder 450 receives information on the wobble channel state and the RF channel state. If a damaged section is discovered from the optical recording medium, the at least one of the PRML module 435, the demodulator 440, and the RS-decoder 450, which received the information, performs an erasure correction of input data corresponding to the damaged section using this channel state information. In other words, the at least one of the PRML module 435, the demodulator 440, and the RS-decoder 450 that received the information uses the error occurrence location information to increase an error correction capability of the apparatus 400.

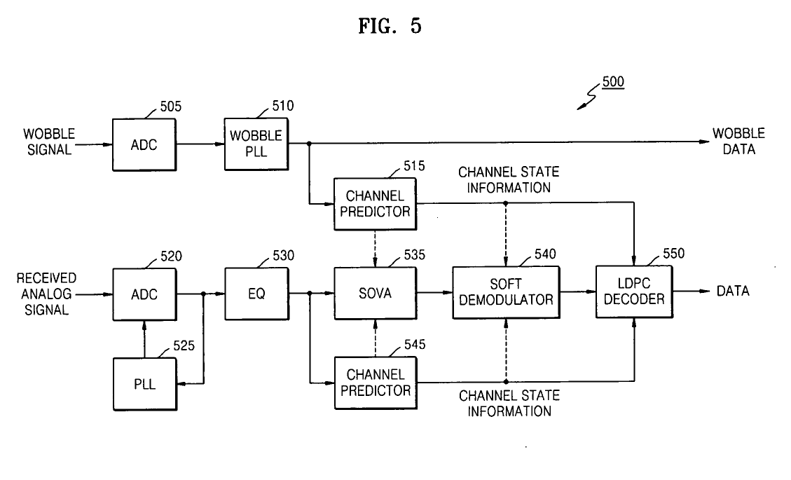

FIG. 5 is a block diagram of an apparatus 500 to record and/or reproduce data onto and/or from an optical recording medium according to another example embodiment of the present invention. For a decoding system which decodes data using a soft decoding method, a PRML module may be replaced with a detector using the soft decoding method as illustrated in FIG. 5.

As shown in FIG. 5, the apparatus 500 includes an ADC 505, a wobble PLL 510, a channel predictor 515, an ADC 520, a PLL 525, an equalizer (EQ) 530, a soft output Viterbi algorithm (SOVA) module 535, a soft demodulator 540, a channel predictor 545, and a low density parity check (LDPC)-decoder 550. The ADC 505 and the wobble PLL 510 detect a wobble signal from a wobble track of the optical recording medium. here, it is noted that the ADC 505 may be omitted or replaced with a slicer. The channel predictor 515 predicts a wobble channel state from the detected wobble signal. The channel predictor 515 then extracts a wobble channel state using envelope information of the wobble signal. That is, the channel predictor 515 extracts the envelope information of the wobble signal, determines that an error has occurred if the envelope of the wobble signal is less than that of a wobble signal in a normal state, and provides channel state information about a damaged section in which the error occurs to at least one of the SOVA module 535, the soft demodulator 540, and the LDPC-decoder 550. According to example embodiments of the invention, a wobble signal envelope detector can be used instead of the channel predictor 515. An abnormal wobble channel state indicates that the wobble signal is damaged, thereby decreasing the envelope of the wobble signal. In this case, if the envelope of the wobble signal is detected, the damaged section can be found.

The ADC 520, the PLL 525, the EQ 530, the SOVA module 535, the soft demodulator 540, and the LDPC-decoder 550 detect an RF signal from the center of a track of an optical recording medium. Although the SOVA module 535 and the LDPC-decoder 550 are used in FIG. 5, the present invention is not limited to a construction in which these devices are used. That is, according to example embodiments of the invention, the SOVA module 535 may be replaced with a channel detector to process a soft value, and the LDPC-decoder 550 may be replaced with a channel decoder to process a soft value. For example, a turbo decoder may be used instead of the LDPC-decoder 550.

The channel predictor 545 predicts an RF channel state from the detected RF signal.

As illustrated in FIG. 5, when the LDPC-decoder 550 is used, a signal having a soft value, which indicates the grade of error occurrence, can be used. That is, a “1” is output if no error occurs, and a value close to “0” is output if the number of errors increases. Accordingly, an error correction capability is increased by adjusting a reliability value of a signal input to the LDPC-decoder 550 using channel state values.

Channel state information can be used by the LDPC-decoder 550 and can be used by either the SOVA module 535 or the soft demodulator 540. That is, in the SOVA module 535, the soft demodulator 540, or the LDPC-decoder 550, an error correction capability of a soft decoder is increased by an increase in the reliability value of a data signal if a channel state is determined to be normal. Similarly, the error correction capability of the soft decoder is increased by a decrease in the reliability value of the data signal if the channel state is determined to be abnormal by channel prediction of the RF signal and the wobble signal. According to example embodiments of the invention, the channel prediction of the RF signal and the wobble signal do not have to be performed at the same time, and predicted error results can be input separately or simultaneously. Since a wobble signal does not exist in a read only disc, a predicted error result of only an RF signal is used.

The soft decoder calculates a reliability of an input signal using probability information of the input signal and uses the calculated reliability in decoding operations. As a result, a relatively excellent error correction capability is achieved. Thus, correct channel state prediction is important to allow for a more correct calculation of data reliability.

If a signal having a soft value close to 0 is input, the possibility of an error in bits of a section corresponding to the soft value is high. Thus, the reliability value of the bits is lowered when an RF signal is decoded. If a signal having a soft value close to 1 is input, the possibility of an error in bits of a section corresponding to the soft value is low. Thus, the reliability value of the bits is increased when an RF signal is decoded.

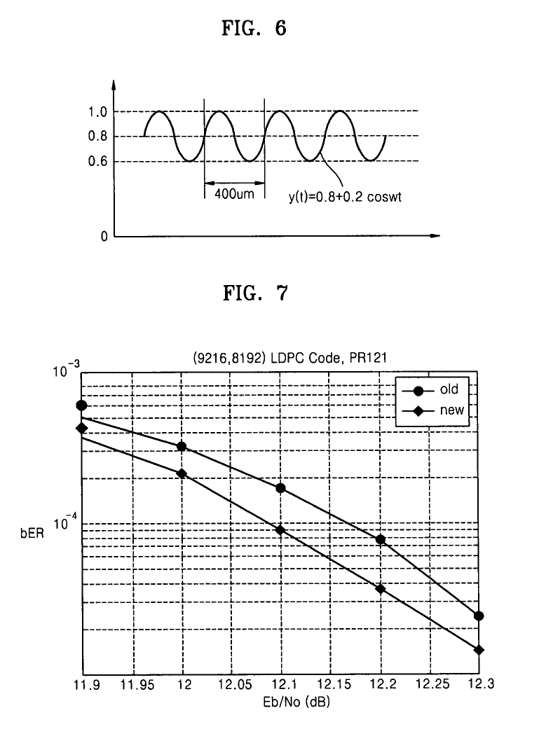

FIG. 6 illustrates a data loss model due to fingerprints, which is used to simulate data reproduction performance according to an embodiment of the present invention. As shown in FIG. 6, a vertical axis indicates the envelope of a signal, and the signal is a sinusoidal wave when data is damaged due to fingerprints.

FIG. 7 is a diagram showing a simulation result that is obtained by an application of the data loss model illustrated in FIG. 6 to a conventional method and to a method according to an embodiment of the present invention. As is illustrated in FIG. 7, a bit error ratio (BER) in the data reproducing method, according to an embodiment of the present invention, is half of a BER in the conventional data reproducing method.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As is described above, according to the present invention, by using information about an RF signal, which is conventionally used, and using envelope information of a wobble signal, the channel state can be predicted using the wobble signal even when the channel state cannot be predicted using only the RF signal, thereby more effectively reproducing data.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A method of reproducing data from an optical recording medium, the method comprising:
detecting a wobble signal from the optical recording medium;
predicting a wobble channel state from the detected wobble signal;
detecting an information signal from the optical recording medium;
predicting an information channel state from the detected information signal; and
if a damaged section is discovered from the optical recording medium, decoding the information signal based on the wobble channel state or the information channel state.

2. The method according to claim 1, wherein the information signal is detected from the optical recording medium using a hard decoding method or a soft decoding method.

3. The method according to claim 1, wherein the decoding comprises:
partial response maximum likelihood (PRML) processing the information signal detected from the optical recording medium;
demodulating the PRML-processed signal; and
Reed-Solomon (RS)-decoding the demodulated signal.

4. The method according to claim 3, wherein the channel state information indicates error occurrence location information, and wherein at least one of the PRML processing, the demodulating, and the RS-decoding comprises performing erasure correction of an information signal on an error occurrence location.

5. The method according to claim 1, wherein the decoding comprises:
a channel detection process in which the information signal detected from the optical recording medium is processed using a soft value;
a soft demodulation process in which the channel detected signal is soft-demodulated; and
a channel decoding process in which the soft-demodulated signal is processed using a soft value.

6. The method according to claim 5, wherein the channel state information indicates envelope information of the wobble signal, and wherein at least one of the channel detection process, the soft demodulation process, and the channel decoding process comprises decreasing the envelope of the information signal to decrease a reliability value of the information signal according to a decrease of the envelope of the wobble signal using the envelope information of the wobble signal.

7. A computer readable medium having a program stored thereon to execute the method according to claim 1.

8. An apparatus to record and/or reproduce data onto and/or from an optical recording medium, the apparatus comprising:
a wobble signal detector to detect a wobble signal from the optical recording medium;
a wobble channel state predictor to predict a wobble channel state from the detected wobble signal;
an information signal detector to detect an information signal from the optical recording medium; and
an information channel state predictor to predict an information channel state from the detected information signal,
wherein, if a damaged section is discovered from the optical recording medium, the information signal detector decodes the information signal based on the information on the wobble channel state or the information on the information channel state.

9. The apparatus according to claim 8, wherein the information signal detector decodes the information signal detected from the optical recording medium using a hard decoding method or a soft decoding method.

10. The apparatus according to claim 8, wherein the information signal detector comprises:
a partial response maximum likelihood (PRML) unit PRML to process the information signal detected from the optical recording medium;
a demodulator to demodulate the PRML-processed signal; and
a Reed-Solomon (RS)-decoder to RS-decode the demodulated signal.

11. The apparatus according to claim 10, wherein the channel state information indicates error occurrence location information, and wherein at least one of the PRML module, the demodulator, and the RS-decoder performs erasure correction of an information signal on an error occurrence location.

12. The apparatus according to claim 8, wherein the information signal detector comprises:
a channel detector to process the information signal detected from the optical recording medium using a soft value;
a soft demodulator to soft-demodulate the channel detected signal; and
a channel decoder to process the soft-demodulated signal using a soft value.

13. The apparatus according to claim 12, wherein the channel state information indicates envelope information of the wobble signal, and wherein at least one of the channel detector, the soft demodulator, and the channel decoder decreases the envelope of the information signal to decrease a reliability value of the information signal according to a decrease of the envelope of the wobble signal using the envelope information of the wobble signal.

14. The apparatus according to claim 12, wherein the channel detector comprises a soft output Viterbi algorithm (SOVA) module, and the channel decoder comprises a low density parity check (LDPC)-decoder or a turbo decoder.

15. A method of improving data error correction capability during data reproducing operations in which the data is reproduced from an optical recording medium, the method comprising:
detecting a wobble signal, including information on a wobble channel state of the data, from a light beam reflected from the optical recording medium;
detecting an information signal, including information on the information channel state of the data, from the light beam reflected from the optical recording medium; and
if a damaged section is discovered from the optical recording medium, decoding the information signal based on the information on the wobble channel state or the information on the information channel state.

16. The method according to claim 15, wherein the decoding comprises decoding the information signal that is detected from the optical recording medium using a hard decoding method or a soft decoding method.

17. The method according to claim 15, wherein the decoding comprises:
partial response maximum likelihood (PRML) processing the information signal detected from the optical recording medium;
demodulating the PRML-processed signal; and
Reed-Solomon (RS)-decoding the demodulated signal.

18. The method according to claim 17, wherein the channel state information indicates error occurrence location information, and wherein at least one of the PRML processing, the demodulating, and the RS-decoding comprises performing erasure correction of an information signal on an error occurrence location.

19. The method according to claim 15, wherein the decoding comprises:
a channel detection process in which the information signal detected from the optical recording medium is processed using a soft value;
a soft demodulation process in which the channel detected signal is soft-demodulated; and
a channel decoding process in which the soft-demodulated signal is processed using a soft value.

20. The method according to claim 19, wherein the channel state information indicates envelope information of the wobble signal, and wherein at least one of the channel detection process, the soft demodulation process, and the channel decoding process comprises decreasing the envelope of the information signal to decrease a reliability value of the information signal according to a decrease of the envelope of the wobble signal using the envelope information of the wobble signal.

21. A computer readable medium having a program stored thereon to execute the method according to claim 15.

22. An apparatus to record and/or reproduce data onto and/or from an optical recording medium, the apparatus comprising:
a wobble signal detector to detect a wobble signal, including information on a wobble channel state, from the optical recording medium;
an information signal detector to detect an information signal, including information on an information channel state, from the optical recording medium; and
wherein, if a damaged section is discovered from the optical recording medium, the information signal detector decodes the information signal based on the information on the wobble channel state or the information on the information channel state.

23. The apparatus according to claim 22, wherein the information signal detector decodes the information signal detected from the optical recording medium using a hard decoding method or a soft decoding method.

24. The apparatus according to claim 22, wherein the information signal detector comprises:
a partial response maximum likelihood (PRML) unit PRML to process the information signal detected from the optical recording medium;
a demodulator to demodulate the PRML-processed signal; and
a Reed-Solomon (RS)-decoder to RS-decode the demodulated signal.

25. The apparatus according to claim 24, wherein the channel state information indicates error occurrence location information, and wherein at least one of the PRML module, the demodulator, and the RS-decoder performs an erasure correction of an information signal on an error occurrence location.

26. The apparatus according to claim 22, wherein the information signal detector comprises:
a channel detector to process the information signal detected from the optical recording medium using a soft value;
a soft demodulator to soft-demodulate the channel detected signal; and
a channel decoder to process the soft-demodulated signal using a soft value.

27. The apparatus according to claim 26, wherein the channel state information indicates envelope information of the wobble signal, and wherein at least one of the channel detector, the soft demodulator, and the channel decoder decreases the envelope of the information signal to decrease a reliability value of the information signal according to a decrease of the envelope of the wobble signal using the envelope information of the wobble signal.

28. The apparatus according to claim 26, wherein the channel detector comprises a soft output Viterbi algorithm (SOVA) module, and the channel decoder comprises a low density parity check (LDPC)-decoder or a turbo decoder.

29. The method according to claim 1, wherein the damaged section is discovered from at least one of the wobble channel state and the information channel state detected from the optical recording medium.
